(19) United States
(12) Patent Application Publication
(10) Pub. No.: US 2002/0017516 A1
(43) Pub. Date: Feb. 14, 2002

(54) Cooking device with disposable insert

(76) Inventors: Laurence W. McKeen, Sewell, NJ (US); W. Douglas Obal, West Chester, PA (US); Richard C. Albert, Landenberg, PA (US)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/851,009

(22) Filed: May 9, 2001

Related U.S. Application Data
(63) Continuation-in-part of application No. 09/638,189, filed on Aug. 14, 2000.
(60) Provisional application No. 60/171,545, filed on Dec. 22, 1999.

(51) Int. Cl. H05B 3/68; H05B 6/12

(52) U.S. Cl. 219/450.1; 219/621

(57) ABSTRACT

The invention provides an electrically heated cooking device having an electrically heated surface for cooking or heating food and a disposable insert of metal foil substrate coated with a nonstick polymer resin. The insert is replaceably affixed to the electrically heated surface so that the nonstick polymer coating on the metal foil substrate is in intimate contact with food being cooked or heated. The invention further provides a method for cooking a meat patty using the cooking device to produce a product with aesthetic appeal and desirable taste in an economic system.

### FIELD OF THE INVENTION

This invention relates to electrically heated cooking devices and replaceable inserts for these devices.

### BACKGROUND OF THE INVENTION

The commercial production of cooked meat products, such as hamburger patties for mass consumption is challenged with producing a tasty product with a tempting appearance, quickly and economically. A common method for producing these products is the use of a two-sided grill, also known as a clamshell cooker. The clamshell cooker is composed of a heated metal base and a heavy, electrically heated, upper metal platen. A frozen, raw hamburger patty is cooked rapidly on both surfaces between the base and the upper platen. In order to insure easy release of the cooked patty without tearing the finished product, the upper metal platen is provided with a nonstick surface layer. That layer has traditionally taken several forms. The nonstick layer can be a thin coating of a nonstick polymer resin directly on the platen as described in U.S. Pat. No. 4,669,373 (Weimer et al). However a directly bonded coating performs under commercial conditions for only about three months and then an expensive recoating operation is required. The coating life can be somewhat extended with careful and time consuming cleaning procedures between cooking cycles, but then only by a couple of months. A replaceable nonstick surface layer has been proposed. In U.S. Pat. No. 4,700,619 (Scanlon) and U.S. Pat. No. 4,320,699 (Binks), a replaceable nonstick layer of synthetic plastic material such as tetrafluoroethylene polymers is disclosed. However, such thin plastic liners are subject to static buildup causing layers to stick to other layers and to fold over on themselves thus being extremely difficult to handle and apply, especially in a commercial setting. To gain handleability, the thickness of the liners may be increased, but this reduces the thermal conductivity needed for cooking. In U.S. Pat. No. 4,729,296 a replaceable nonstick surface layer of polytetrafluoroethylene-impregnated glass fiber cloth is proposed. However the aforementioned replaceable options result in a food product with less appeal, both visual and taste. The resulting hamburger patty is less seared on its top surface than the bottom surface, somewhat gray in appearance, and less flavorful.

The fast food industry has a need for a disposable nonstick layer for commercial cooking devices that can rapidly produce a product with improved aesthetic appeal and desirable taste in an economic system.

### BRIEF SUMMARY OF THE INVENTION

The present invention provides an electrically heated cooking device having an electrically heated surface for cooking or heating food and a disposable insert of metal foil substrate coated with a nonstick polymer resin. The insert is replaceably affixed to the electrically heated surface so that the nonstick polymer coating on the metal foil substrate is in intimate contact with food being cooked or heated.

The present invention also provides for a two-sided cooking device having a heated metal base with a surface to receive food to be cooked; an upper heated metal platen positioned over the metal base; and a disposable insert of a metal foil substrate coated with a nonstick polymer resin. The insert is replaceably affixed to at least the upper platen and positioned so that the nonstick polymer coating on the metal foil substrate is in intimate contact with food on the heated base when the upper platen engages the metal base during the process of cooking.

The present invention further provides a process for cooking food by placing uncooked food on a heated metal base, lowering a heated metal platen affixed with a disposable insert of metal foil coated with a nonstick fluoropolymer resin over the food so that the insert is in intimate contact with the food, the heat flowing through the coated insert causing the food to cook, lifting the metal platen from the food leaving little food residue on the insert; and removing the cooked food from the heated metal base, wherein the process results in substantially equivalent browning on both sides of the food.

The present invention also provides a disposable insert of special design that prolongs the cooking life of the insert and reduces the cleaning necessary for the upper platen on which the insert is mounted. This insert is replaceably mounted on the upper platen and is made of nonstick polymer-coated metal foil as described above. The insert, however, not only has a base portion which corresponds to the heating surface of the upper platen, but also has a sidewall portion extending out of the plane of the base portion to form a box shape, the side opposite from the base portion being open, the outside of the box shape having the nonstick coating thereon. When mounted on the upper platen, the box shape of the insert wraps around the upper platen to form a barrier to cooking volatiles (smoke) contacting the heating surface of the upper platen, thereby reducing the formation of carbon on such heating surface and the need to clean such upper surface.

### BRIEF DESCRIPTION OF THE DRAWING(S)

FIG. 1 is a side view of the disposable insert of this invention for use in an electrically heated cooking device.

FIG. 2 is a side view of a two-sided cooking device, a preferred embodiment of this invention, showing the disposable insert of FIG. 1 replaceably affixed to the upper metal platen of the device.

FIG. 3 is a plan view of another embodiment of disposable insert of this invention.

FIG. 4 is an isometric, schematic view of the insert of FIG. 3 after folding into an open-top box-like shape.

FIG. 5A is a enlarged plan view of one corner of the insert of FIG. 4 showing the folded construction of one corner thereof at the front of the box-like shape.

FIG. 5B is an enlarged plan view of a back corner of the insert of FIG. 4 showing the folded construction thereof.

FIG. 6 is an enlarged isometric view of a modification of the back corner shown in FIG. 5B.

FIG. 7 is a side view of a two-sided cooking device showing the insert of FIG. 4 positioned over the upper platen of the device.

### DETAILED DESCRIPTION

The present invention satisfies a long-felt need in the fast food industry by providing a disposable insert for an electrically heated cooking device that is economical to produce, exhibits excellent nonstick performance and has excellent heat transfer characteristics.

A disposable insert 10 for an electrically heated cooking device according to this invention is shown in FIG. 1. The insert is illustrated as having two layers, metal foil substrate 12 and nonstick polymer resin 14. The two layer construction provides ease in handling, good thermal conductivity and the desired release properties. The foil substrate provides the insert with integrity for easy handling and with good heat transfer. The thin nonstick polymer resin coating confers the needed release properties without hindering thermal conductivity. The metal foil is any foil of heat conducting metal, but preferably aluminum or stainless steel having a thickness of from about 0.6 mils (15 micrometers) to about 12 mils (300 micrometers), preferably 4 to 8 mils (100 to 200 micrometers). The nonstick polymer resin may be a single coating or a multilayer coating of any heat resistant nonstick polymer resin. The total dry film thickness (dft) of the nonstick polymer resin coating is from about 0.1 mil (2.5 micrometers) to about 3 mils (76 micrometers), preferably 0.3 mil (8 micrometers) to 1.5 mils (38 micrometers), most preferably 0.3 mil (8 micrometers) to 1 mil (25 micrometers). The thickness of the foil and the nonstick coating are optimized to obtain desired heat transfer characteristics as well as performance, desired service life and ease of handling. In the preferred embodiment the surface of the insert is uninterrupted with perforations. However the insert may be stamped or formed to conform to the surfaces of a specific cooking device, for example a waffle iron.

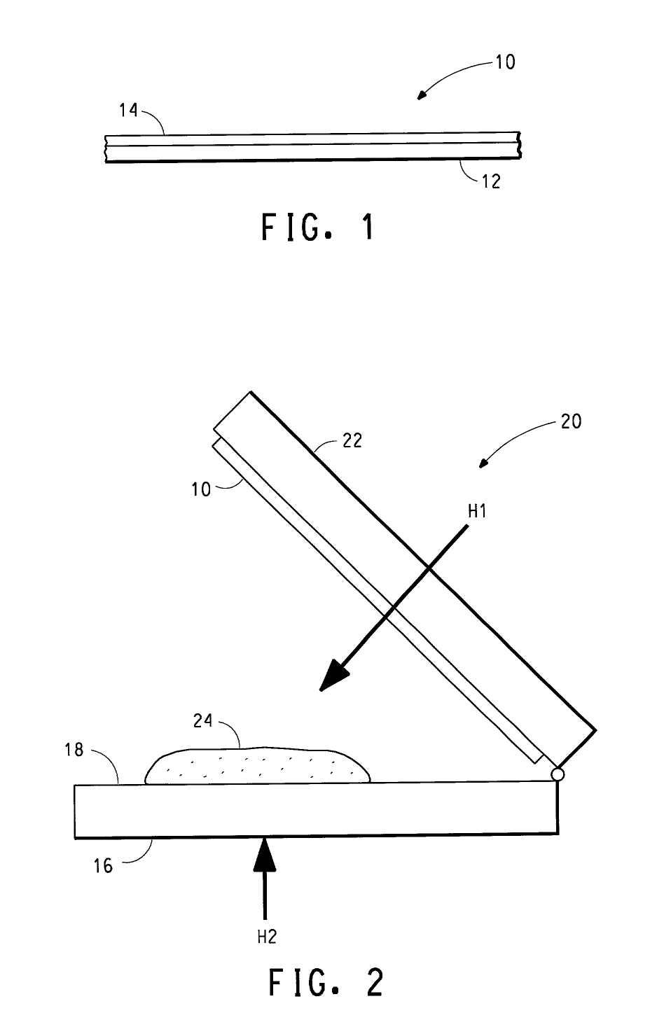

An electrically heated cooking device 20 having an electrically heated surface for heating or cooking food and a disposable insert of metal foil with nonstick polymer resin coating according to the present invention is shown in FIG. 2. For purposes of illustrating the invention, a two-sided cooking device is described although the advantages of the invention are recognized as extending to devices with other configurations, including a one-sided cooking device. The disposable inserts of the present invention can be used with cooking devices made of any material such as aluminum, stainless steel, cast iron, ceramic etc.

In FIG. 2, a two-sided cooking device is shown with a heated metal base 16 having a surface 18 to receive food to be cooked and an upper heated metal platen 22 positioned in hinged relationship over the base 16. A disposable insert 10 of metal foil coated with nonstick polymer resin is replaceably affixed with metal clips (not shown) to at least the upper platen 22. In some or most situations, it may be advantageous to affix the disposable inserts of the present invention to both cooking surfaces, to prevent sticking to either the upper or lower cooking surface. Positioned on cooking surface 18 is a meat patty 24. Although a meat patty is used for illustration, any food suitable for heating or cooking on the surface of a fast food electrically heated cooking device may be used, such as steaks, muffins, bagels, waffles, pancakes, potato patties, fish cakes, soy burgers, chicken filets, eggs, hot dogs, etc. In operation, upper platen 22 engages heated metal base 16 during the process of cooking the patty. Disposable insert 10, with the nonstick coated surface facing the meat patty, comes in intimate contact with the patty 24, transferring heat from the platen 22 through the conducting metal foil substrate 12 and nonstick resin coating 14 as illustrated by arrow H1. During the cooking process, heat is also transferred through base 16 as illustrated by arrow H2. The meat patty is in this way cooked on both sides. Because of the excellent heat transfer characteristics of the disposable insert of this invention the meat patty is equally seared on both sides, conferring both a better visual appearance and improved taste as compared to patties cooked with cooking devices employing prior art disposable inserts.

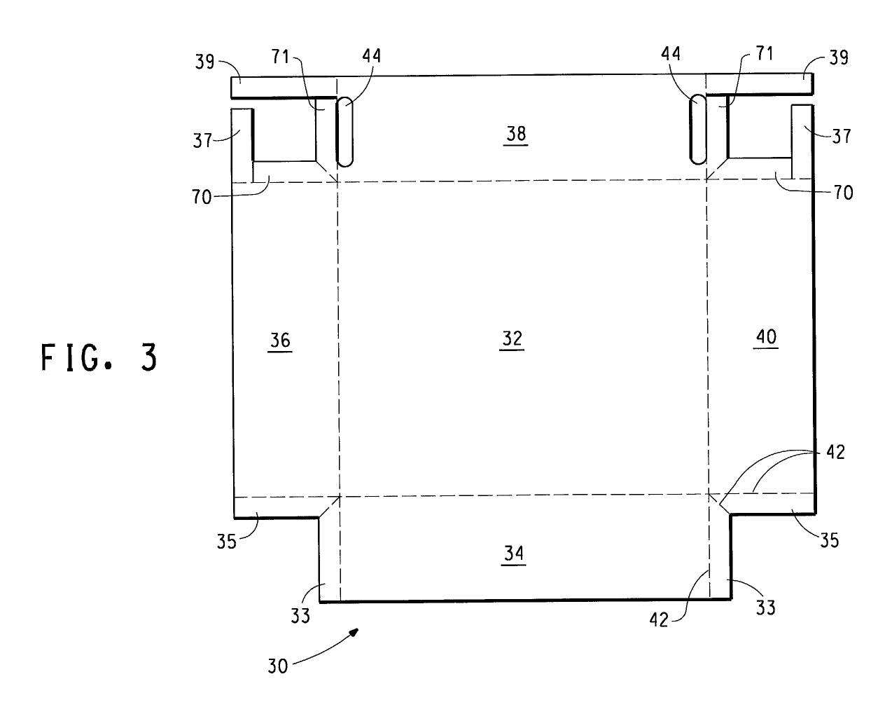

FIGS. 3 to 6 show another embodiment of the present invention. FIG. 3 shows a disposable insert 30 which has been stamped or otherwise cut out of a planar sheet or strip of metal foil. The insert 30 comprises a base portion 32 and sidewall portions 34, 36, 38, and 40. Sidewall portions 36 and 40 have tabs 37 extending therefrom, and sidewall 38 has tabs 39 extending from it. Fold lines in insert 30 are shown as dashed lines 42 in FIG. 3. The fold lines at each end of sidewall 34 form sidewall flaps 33. Fold lines at one end of sidewalls 36 and 40 form sidewall flaps 35, and the fold lines at the opposite ends of sidewalls 36 and 40 also form sidewall flaps 70. The same is true for the fold lines at the ends of sidewall 38, forming sidewall flaps 71. Tabs 37 and 39 extend to the fold line forming flaps 70 and 71 so that they may be folded independently. Mounting slots 44 are punched or otherwise cut into sidewall 38 bordering fold lines in the sidewall as shown in FIG. 3 . The base portion 32, sidewall portions 34, 36, 38, and 40 and the tabs and flaps are all in the same plane.

FIG. 4 shows the insert 30 of FIG. 3 after folding along lines 42 to form a box shape, with the side opposite base portion 32 being open. In the disposition shown in FIG. 4, the box shape is open at the top

The insert 30 also comprises a coating of nonstick polymer resin on the metal foil, such coating being present on the underside of the metal foil forming insert 30 of FIG. 3, whereby the nonstick coating is not visible. Upon erection of this insert into the box shape of FIG. 4, the nonstick coating is shown as coating 46 on the outside of the sidewalls 34, 36, 38, and 40. The coating is also present on the underside of base portion 32. The metal foil forming insert 30, i.e. the substrate thereof for the coating 46, and the coating 46 are shown in exaggerated thickness so as to be visible in FIG. 4. The metal foil and coating are very thin for reasons of cost, i.e. the insert is disposable, and for high efficiency of heat transfer between the platen over which the insert is used and the food being cooked. The foil, however, is thick enough that once folded into the box shape, it retains this shape, even upon handling, such as for shipping and installation into a cooking device. Thus the metal foil is the strength component of the insert 30, while the nonstick coating provides the nonstick property of the insert. The metal foil and non-stick coating thicknesses disclosed herein are applicable to this embodiment.

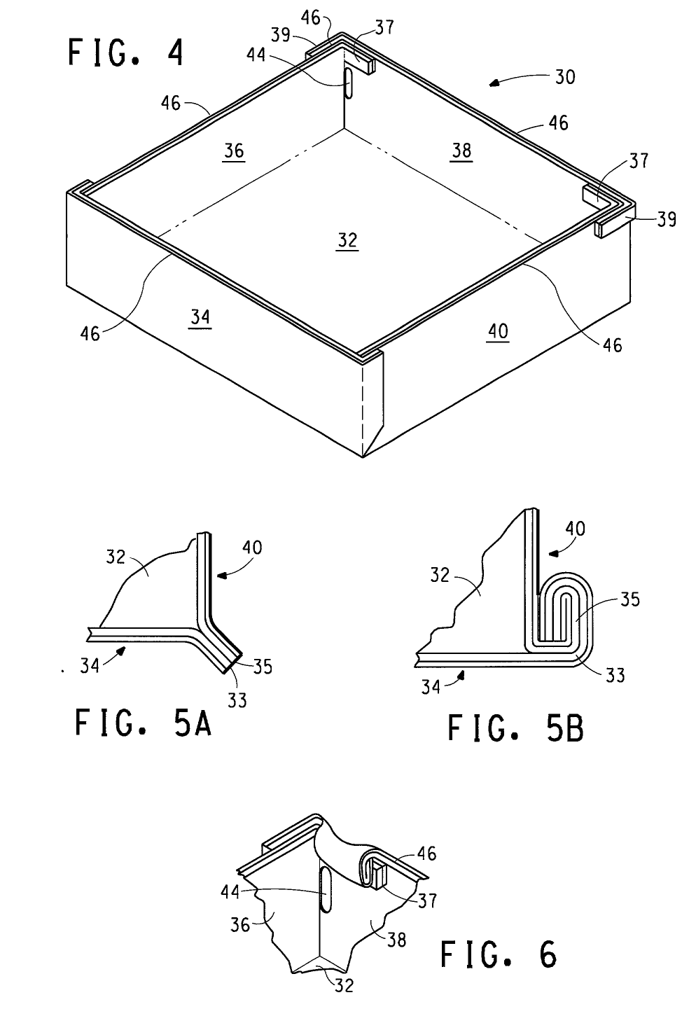

FIG. 5A and 5B show in sequence and detail how the corners of the box shape at the front of the box shape can be held together. FIG. 5A shows the sidewall flap 33 of sidewall 34 brought together with sidewall flap 35 of sidewall 40. FIG. 5B shows the crimping of these flaps 33 and 35 together by bending flap 33 around flap 35. Flaps 33 and 35 can be secured together by multiple bends around one another. Flaps 70 and 71 are secured together in the same way to form the back corners of the box shape. The mounting slots 44 are in the rear sidewall of the box shape.

In FIG. 4, the tabs 37 and 39 are shown to lie snug against their adjacent sidewall. These tabs can also be used to strengthen the rear corners of the box shape, especially that portion of sidewall 38 that lies above the mounting slots 44. Because of the light construction (thin metal foil) of the insert, the mounting slots are prone to tearing unless carefully handled by the installer of the insert onto the upper platen. One method of strengthening is to secure the tab against its respective sidewall by using a clip (not shown) which clamps the tab and sidewall one to the other. This provides a double thickness for the region above each mounting hole 44 to double the resistance to tearing. FIG. 6 shows another method. In FIG. 6, the sidewall 38 is shown bent around tab 37, similar to the bending around of the flaps shown in Figure 5B, this providing a triple thickness to tearing above the mounting slot 44. This bending, too can be multiple bending to further increase the resistance against tearing. Preferably the multiple thicknesses of sidewall 38 obtained by this bending extend to the upper edge of the slots 44 so as to maintain their integrity upon installation and removal from the upper metal platen of a two-sided cooking device as will be described hereinafter. This method of strengthening can be used at both back corners of the box shaped insert. Sidewalls 36 and 40 can also be bent around their respective flaps 39 to provide further strengthening. Instead of using both flaps 70 and 71 for crimping together to form the rear corners of the box shape, flaps 71 can be omitted so that the erection of the sheet insert 30 into the box shape essentially forms the slots 44, accompanied by some cutting out of these slots in the sidewall 38. In this embodiment (not shown), flaps 70 can be enlarged in the direction of tabs 39, and these flaps can then be rolled over (crimped) itself to add strength to the rear corners of the box shape. In still another embodiment (not shown), the height direction of the sidewalls 34, 36, 38,and 40 can be increased to extend beyond the ends of flaps 33 and 35 and tabs 37 and 39, and the resultant extended portion can then be rolled over (crimped) onto itself to form reinforced top edges for the box shape.

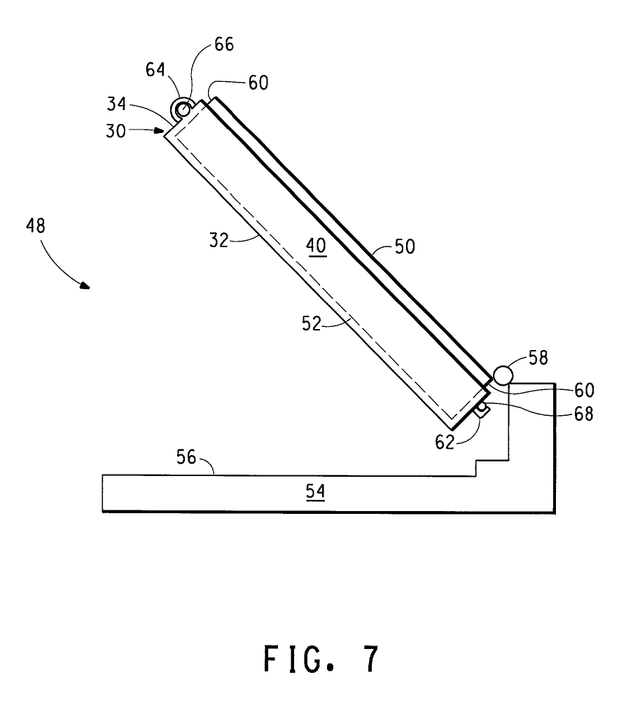

FIG. 7 shows the installation of the insert 30 formed into the box shape of FIG. 4 onto the upper metal platen 50 of a two-sided cooking device or clamshell cooker 48. Sidewall 40 and an edge of base portion 32 of insert 30 are visible in this Figure. Upper metal platen 50 has its heating surface 52 facing the lower platen 54, which has its heating surface 56 facing that of the upper platen. The upper platen is attached to a support structure defining the rear of the lower platen via hinge 58, which enables the upper platen to be lowered and raised to cook and release food placed on the heating surface 56 of lower platen 54. Commercial two-sided cookers have varying ways of pivotally mounting the upper platen to support structure which contains the lower platen, and the box shape insert of the present invention can be modified to accommodate the different mountings. The upper platen 50 comprises housing structure which supports its heating surface 52, which in the embodiment shown includes a sidewall 60 which encases the periphery of heating surface 52 and maintains its position on the lower side of the upper platen. As in the case of the cooking device of FIG. 2, the upper and lower platens will generally be made of metal.

The sidewalls 34, 36, 38, and 40 overlap the sidewall 60 of the upper platen on all four sides. Thus, the insert 30 wraps around the upper platen. In the embodiment shown, this overlap is almost of the entire sidewall 60 of the upper platen. The insert 30 is held in place wrapped around the heating surface 52 and sidewall 60 of the upper platen by (a) hooks 62 (only one shown) extending from the rear sidewall of the upper platen and engaging slots 44 in sidewall 38 of the insert and (b) by clamp 64 which grips sidewall 34 as the clamp partially encircles rod 66 fastened along a portion of the length of the sidewall 60 on the front of the upper platen 50. The insert 30 is sufficiently flexible that the clamp can force the sidewall 34 into the shape of the rod 66 so as to be clamed by clamp 64. A removable rod 68 is shown positioned within the eye of hook 62 to prevent the insert from disengaging the hook unless the rod is removed. The rod 68 extends along the rear sidewall of the upper platen to engage the eye of the hook (not shown) at the opposite end of the platen sidewall, thereby retaining that end of the insert in place as well.

The inner dimension of the box shape of the insert 30 is about the same as the outer dimension of the sidewall 60 of the upper platen so that the fit of the insert over the upper platen 50 is snug, with the base portion 32 of the insert being as close as possible to the heating surface 56 on the bottom platen. To the extent the base portion 32 is not in contact with the heating surface 52 upon installation of insert 30 onto upper platen 50, the presence of food on the heating surface 56 of lower platen 54 will force the base portion into contact with the heating surface 52 for efficient heat transfer from the heating surface 52 through the base portion 32 and into the food being cooked. The presence of the coating of nonstick polymer on the underside of base portion 32 releases the food being cooked upon raising of the upper platen 50.

This embodiment of the present invention prolongs the life of the disposable non-stick coated metal foil insert by keeping the heating surface of the upper platen clean for long periods of use, whereby the insert does not have to be removed frequently for cleaning of the heating surface. Thus, while being built to be disposable, the insert nevertheless has a long life. The reduction in need for cleaning of the heating surface of the upper platen, provides considerable savings in the expense of cleaning and avoidance of this very difficult manual job.

With the disposable insert 30 wrapping around the upper platen, the volatiles generated by cooking, visible as smoke emanating from the cooking device, are not able to get behind the insert to deposit on the heating surface of the upper platen. To the extent such volatiles are able to so deposit, the continued use of the heating surface for cooking causes the volatiles to form carbon deposit on the heating surface 52 of the upper platen. Such carbon deposit forms a heat insulation barrier between heating surface 52 and the food being cooked. The disposable insert of the present invention which covers only the heating surface of the upper platen does an excellent job in preventing the volatiles (smoke) from contacting the heating surface of the upper platen by permeation through the insert itself, i.e. the insert is impermeable to such volatiles, but some portion of the volatiles is able to reach the heating surface of the upper platen around the ends of the insert. Where the insert ends, the smoke is able to get behind the insert and thus come into contact with the heating surface of the upper platen, resulting in the eventual buildup of carbon deposit on the heating surface of the upper platen. Removal of the disposable insert for clean up of the heating surface can result in damage to the insert, even perforation, so that upon re-installation, the insert is much less efficient in the rapid cooking process generally desired. The wrap-around disposable insert embodiment of the present invention as shown in FIG. 6 serves as a much improved barrier to the volatiles from cooking reaching the heating surface of the upper platen. The sidewalls 34, 36, 38, and 40, form a barrier to the volatiles as they emanate from the cooking device. Thus, this embodiment enables the disposable insert to remain in place on the upper platen for a longer time than if the insert only covered the heating surface, as demonstrated in Example 4. The sidewall 60 need only be partially covered by the sidewalls of the insert, but it is preferred that the sidewall extend up at least 40%, preferably at least 60% of the height of the sidewall 60 of the upper platen, and more preferred, to over lap the entire sidewall 60.

Many different ways of converting the insert 30 in the flat sheet form to a stable open-top-box shape can be used, i. e. the folding pattern can be different to produce a different arrangement of flaps at the comers of the box shape, it only being desired that the corners be strong and essentially impervious to volatiles so as to prevent the volatiles from reaching the heating surface of the upper platen by entry through the corner(s) of the box shape of the insert. Other possibilities for removably attaching the insert 30 to the upper platen than shown in FIG. 6 can be used.

The nonstick coating on disposable insert 30, insofar as the base portion 30 is concerned, forms the release function for the food being cooked. The presence of the nonstick coating on the outside of the sidewalls 34, 36, 38, and 40 as shown in FIG. 4 is preferred for ease of cleanup of the outside of the upper platen. This too prolongs the life of the disposable insert by enabling the upper platen to have a clean appearance, and indeed be clean, without removing the disposable insert. Thus, the insert of the present invention which includes the sidewalls forming an open box shape has a life in use which is defined by the life of the nonstick coating on the base portion of the insert rather than injury to the insert during removal and reinstallation caused by the need to clean the heating surface of the upper platen.

The improved heat transfer characteristics of the cooking device of the present invention is best represented by comparing this invention to a prior art device which uses a disposable insert of polytetrafluoroethylene-impregnated glass fiber cloth. Heat transfer is described according to the following equation:

$$\frac{Δ q}{Δ t} = kA \frac{( {T}_{2} - {T}_{1} )}{L} \qquad ( 1 )$$

where:

| | | |
|---|---|---|
| Δq | = | heat |
| Δt | = | time |
| k | = | coefficient of thermal conductivity |
| T₂ | = | temperature of upper platen |
| T₁ | = | temperature of patty |
| L | = | thickness of release film |
| A | = | area. |

TABLE 1

| | k | Thickness |
|---|---|---|
| Material | (Wm⁻¹K⁻¹) | (micrometers) |
| Glass/PTFE cloth | 0.35-0.42 | 125 |
| Aluminum Foil | 237 | 25 |
| Nonstick Resin | 0.20 | 10-15 |

Because aluminum is so much more conductive than the nonstick resin it can be ignored as shown in equation (2) when expanded to include a two layered material with subscript m for aluminum, subscript n for the nonstick polymer resin coating:

$$\frac{Δ q}{Δ t} = kA \frac{( {T}_{2} - {T}_{1} )}{( {L}_{m} / {k}_{m} ) + ( {L}_{n} / {k}_{n} )} . \qquad ( 2 )$$

For example, if the aluminum thickness is 25 micrometers and its coefficient of thermal conductivity is 237, the aluminum term is very small (25/237=0.1) when compared to the coating term (15/0.2=75) and therefore can be ignored.

The area, A, and the temperature differential (T₂-T₁) are constants (same patty, same starting temperatures), therefore

$$\frac{Δ q}{Δ t} ∝ \frac{k}{L} \qquad ( 3 )$$

As shown in Table 2, relative heat transfer of the insert of the present invention is about four times greater than the fluoropolymer impregnated fiberglass cloth insert presently used in the industry today.

TABLE 2

| | Relative |
|---|---|
| Material | Heat Transfer |
| Glass/PTFE cloth | 0.00336 |
| Aluminum foil/ | 0.01333 |
| Nonstick Resin | |

In addition to superior appearance and taste, the cooking device of this invention has been found to cook food quickly. In a two-sided cooking device as described, it has been found that the interior portions of meat can be heated to the necessary degree of doneness more quickly than when compared to cooking devices using inserts of the prior art. Further the nonstick coating on the metal foil insert prevents the meat patty from sticking to the platen or from breaking apart when the cooking operation is completed and the upper platen is raised. The smooth nonstick surface of the coated foil insert on the upper platen may be maintained free and clear of any adherent food by simply wiping the surface with a damp cloth, if desired. The surface is uninterrupted with perforations. Therefore, fats and meat residue cannot seep through to the platen and adversely affect performance and cause additional cleaning problems. In contrast, the fluoropolymer impregnated glass cloth insert commonly used in commercial cooking today has a rough textured porous surface that food residue can cling to and oils can permeate, necessitating daily removal and thorough washing of the insert as well as cleaning of the platen. The insert of the present invention is easy to clean as well as being an economical construction that can be discarded and replaced with a new insert frequently to maintain the highest level of sanitary conditions for a commercial cooking establishment.

The cooking device of the present invention permits the efficient and safe preparation of food in a commercial setting. Food can be cooked or heated by placing food on a heated metal base, lowering a heated metal platen affixed with a disposable insert of metal foil coated with a nonstick fluoropolymer resin over the food so that the insert is in intimate contact with the food, the heat flowing through the coated insert causing the food to heat or cook, lifting the metal platen from the food leaving little food residue on the insert; and removing the heated/cooked food from the heated metal base. Food cooked by this process has substantially equivalent browning on both sides of the food product.

For example, a meat patty can be commercially cooked by placing a frozen, raw meat patty on a heated metal base, lowering a heated metal platen affixed with a disposable insert of metal foil coated with a nonstick fluoropolymer resin over the patty so that the insert is in intimate contact with the patty, the heat flowing through the coated insert causing the internal temperature of said patty to reach at least 156° F. (69° C.), lifting the metal platen from said patty leaving little meat residue on the insert; and removing the cooked meat patty from the heated metal base. Frozen, raw meat patties weighing approximately 4 ounces cooked by this process reach an internal temperature of at least 156° F. (69° C.), preferably in less than 108 seconds, more preferably in less than 100 seconds, and most preferably in less than 90 seconds. Cooked meat patties produced according to this process have substantially equivalent searing on both sides of the patty.

### Nonstick Polymer Resin

The nonstick polymer resin of this invention can be anyone of a number of resins including silicone resins, fluorine containing resins, and especially perfluoropolymers.

The fluoropolymer component of the nonstick coating composition of this invention is preferably polytetrafluoroethylene (PTFE) having a melt viscosity of at least 1×10⁸ Pas•s at 380° C. for simplicity in formulating the composition and the fact that PTFE has the highest heat stability among the fluoropolymers. Such PTFE can also contain a small amount of comonomer modifier which improves film-forming capability during baking (fusing), such as perfluoroolefin, notably hexafluoropropylene (HFP) or perfluoro(alkyl vinyl) ether, notably wherein the alkyl group contains 1 to 5 carbon atoms, with perfluoro(propyl vinyl ether) (PPVE) being preferred. The amount of such modifier will be insufficient to confer melt-fabricability to the PTFE, generally being no more than 0.5 mole %. The PTFE, also for simplicity, can have a single melt viscosity, usually at least 1×10⁹ Pa•s, but a mixture of PTFEs having different melt viscosities can be used to form the fluoropolymer component. Use of a single fluoropolymer in the composition, which is the preferred condition, means that the fluoropolymer has a single chemical identity and melt viscosity.

While PTFE is preferred, the fluoropolymer component can also be melt-fabricable fluoropolymer, either combined (blended) with the PTFE, or in place thereof. Examples of such melt-fabricable fluoropolymers include copolymers of TFE and at least one fluorinated copolymerizable monomer (comonomer) present in the polymer in sufficient amount to reduce the melting point of the copolymer substantially below that of TFE homopolymer, polytetrafluoroethylene (PTFE), e.g., to a melting temperature no greater than 315° C. Preferred comonomers with TFE include the perfluorinated monomers such as perfluoroolefins having 3-6 carbon atoms and perfluoro(alkyl vinyl ethers) (PAVE) wherein the alkyl group contains 1-5 carbon atoms, especially 1-3 carbon atoms. Especially preferred comonomers include hexafluoropropylene (HFP), perfluoro(ethyl vinyl ether) (PEVE), perfluoro(propyl vinyl ether) (PPVE) and perfluoro(methyl vinyl ether) (PMVE). Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms). The molecular weight of the melt-fabricable tetrafluoroethylene copolymers is unimportant except that it be sufficient to be film-forming and be able to sustain a molded shape so as to have integrity in the primer application. Typically, the melt viscosity will be at least 1×10² Pa•s and may range up to about 60-100×10³ Pa•s as determined at 372° C. according to ASTM D-1238.

The fluoropolymer component is generally commercially available as a dispersion of the polymer in water, which is the preferred form for the composition of the invention for ease of application and environmental acceptability. By “dispersion” is meant that the fluoropolymers particles are stably dispersed in the aqueous medium, so that settling of the particles does not occur within the time when the dispersion will be used; this is achieved by the small size of the fluoropolymer particles, typically on the order of 0.2 micrometers, and the use of surfactant in the aqueous dispersion by the dispersion manufacturer. Such dispersions can be obtained directly by the process known as dispersion polymerization, optionally followed by concentration and/or further addition of surfactant. In some cases it is desirable to include an organic liquid, such as N-methylpyrrolidone, butyrolactone, high boiling aromatic solvents, alcohols, mixtures thereof, among others in the aqueous dispersions.

Alternatively, the fluoropolymer component may be a fluoropolymer powder such as PTFE micropowder. In which case, typically an organic liquid is used in order to achieve an intimate mixture of fluoropolymer and polymer binder. The organic liquid may be chosen because a binder dissolves in that particular liquid. If the binder is not dissolved within the liquid, then the binder can be finely divided and be dispersed with the fluoropolymer in the liquid. The resultant coating composition can comprise fluoropolymer dispersed in organic liquid and polymer binder, either dispersed in the liquid or dissolved in order to achieve the intimate mixture desired. The characteristics of the organic liquid will depend upon the identity of the polymer binder and whether a solution or dispersion thereof is desired. Examples of such liquids include N-methylpyrrolidone, butyrolactone, high boiling aromatic solvents, alcohols, mixtures thereof, among others. The amount of the organic liquid will depend on the flow characteristics desired for the particular coating application operation.

### Polymer Binder

A fluoropolymer composition of this invention preferably contains a heat resistant polymer binder. The binder component is composed of polymer that is film-forming upon heating to fusion and is also thermally stable. This component is well known in primer applications for nonstick finishes, for adhering the fluoropolymer-containing primer layer to substrates and for film-forming within and as part of a primer layer. The fluoropolymer by itself has little to no adhesion to a smooth substrate. The binder is generally non-fluorine containing and yet adheres to the fluoropolymer. Preferred binders are those that are soluble or solubilized in water or a mixture of water and organic solvent for the binder, which solvent is miscible with water. This solubility aids in the blending of the binder with the fluorocarbon component in the aqueous dispersion form.

An example of the binder component is polyamic acid salt that converts to polyamideimide (PAI) upon baking of the composition to form the primer layer. This binder is preferred because in the fully imidized form obtained by baking the polyamic acid salt, this binder has a continuous service temperature in excess of 250° C. The polyamic acid salt is generally available as polyamic acid having an inherent viscosity of at least 0.1 as measured as a 0.5 wt % solution in N,N-dimethylacetamide at 30° C. It is dissolved in a coalescing agent such as N-methylpyrrolidone, and a viscosity-reducing agent, such a furfuryl alcohol and reacted with tertiary amine, preferably triethylamine, to form the salt, which is soluble in water, as described in greater detail in U.S. Pat. 4,014,834 (Concannon). The resultant reaction medium containing the polyamic acid salt can then be blended with the fluoropolymer aqueous dispersion, and because the coalescing agent and viscosity-reducing agent are miscible in water, the blending produces a uniform coating composition. The blending can be achieved by simple mixing of the liquids together without using excess agitation so as to avoid coagulation of the fluoropolymer aqueous dispersion. Other binder resins that can be used include polyether sulfone (PES) and polyphenylene sulfide (PPS).

When the primer composition is applied as a liquid medium, wherein the liquid is water and/or organic solvent, the adhesion properties described above will manifest themselves upon drying and baking of the primer layer together with baking of the next-applied layer of fluoropolymer to form the nonstick coating on the metal foil substrate.

For simplicity, only one binder may be used to form the binder component of the composition of the present invention. However, multiple binders can also be used in this invention, especially when certain end-use properties are desired, such as flexibility, hardness, or corrosion protection. Common combinations include PAI/PES, PAI/PPS and PES/PPS.

The proportion of fluoropolymer and binder, especially if the composition is used as a primer layer on a smooth metal foil substrate, is preferably in the weight ratio of 0.5 to 2.0:1. The weight ratios of fluoropolymer to binder disclosed herein are based on the weight of these components in the applied layer formed by baking the composition after application to its metal foil substrate. The baking drives off the volatile materials present in the coating composition, including the salt moiety of the polyamic acid salt as the imide bonds are formed during baking. For convenience, the weight of binder, when it is polyamic acid salt which is converted to polyamideimide by the baking step, can be taken as the weight of polyamic acid in the starting composition, whereby the weight ratio of fluoropolymer to binder can be determined from the amount of fluoropolymer and binder in the starting composition. When the composition of the invention is in the preferred aqueous dispersion form, these components will constitute about 5 to 50 wt % of the total dispersion.

In addition to the fluoropolymer and/or polymer binder, the nonstick coating compositions of this invention may contain particles of inorganic filler film hardener and optionally pigments. Suitable inorganic filler film hardeners include particles of aluminum oxide, silicon carbide etc. as well as glass flake, glass bead, glass fiber, aluminum or zirconium silicate, mica, metal flake, metal fiber, fine ceramic powders, silicon dioxide, barium sulfate, talc, etc.

### Coating Application

The compositions of the present invention can be applied to metal foil substrates by conventional means. Spray and roller applications are the most convenient application methods, depending on the substrate being coated. Other well-known coating methods are suitable, for example coil coating. The nonstick coating compositions may be a single coat or a multi-coat system comprising an undercoat and an overcoat.

### EXAMPLES

### Example 1

### Single Coat System

Fluoropolymer

PTFE micropowder with a bulk density greater than 250 and less than 1000 g/l measured by ASTM D4894; a melt range greater then 315° C. and less than 350° C. measured by ASTM D4894; average particle size (on a volume basis) of 4 to 12 micrometers as determined by Laser Microtrac; specific surface area of 8 to 12 m²/g as determined by nitrogen absorption; specific gravity of 2.2 to 2.3 g/cm³.

Polymer Binder

Polyethersulfone: Resin available from BASF Corporation designated ULTRASON E-2020 PEARL PE SULFONE.

Solvents

N-Methyl Pyrrolidone: available from BASF Corporation designated N-METHYL PYRROLIDONE.

Methyl Isobutyl Ketone: available from Eastman Chemical Company designated METHYL ISOBUTYL KETONE (HEXONE).

A nonstick polymer resin of PTFE micropowder and PES (50/50 weight ratio) is prepared by mixing 495 grams N-methyl pyrrolidone and 126 grams of polyethersulfone until a clear solution is obtained with a propeller type of mixer at 60-100 rpms. While mixing, 253 grams methyl isobutyl ketone are added and the mixing is continued for 15 more minutes. The mixer speed is then increased to make a strong vortex and 126 grams PTFE is added. Mixing is continued until the powder is well mixed, about one hour. The mixture in then ground in a horizontal media mill.

A 1 mil (25 micrometers) thick sheet of aluminum foil is prepared for coating by simply wiping clean the unroughened sheet clean with a cloth wiper moistened with N-Methyl Pyrrolidone. The nonstick coating resin mixture is applied to the dull side of the aluminum sheet by spray coating to a dry film thickness of between 0.3-0.5 mils (8-13 micrometers). The coated foil is baked for five minutes at 750° F. (399° C.) to produce a disposable insert for use in an electrically heated cooking device. The baked film is semi-gloss, clear or yellow and the surface is very smooth. Cooking tests for a cooking device using the insert are described in Example 3.

### Example 2

### Two Coat System

Fluoropolymer Components

PTFE dispersion: TFE fluoropolymer resin dispersion with a solids content of 60 wt %, standard specific gravity (SSG) 2.25 measured according to ASTM D4895 and raw dispersion particle size (RDPS) 0.18-0.28.

FEP dispersion: TFE/HFP fluoropolymer resin dispersion with a solids content of 54.5-56.5 wt % and RDPS of from 150-210 nanometers, the resin having an HFP content of from 9.3-12.4 wt. % and a melt flow rate of 11.8-21.3 measured at 372° C. by the method of ASTM D-1238 modified as described in U.S. Pat. No. 4,380,618.

PFA dispersion: TFE/PPVE fluoropolymer resin dispersion with a solids content of 58-62 wt % and RDPS of from 185-245 nanometers, with a PPVE content of 3.0-4.6 wt. %, and a melt flow rate of 1.3-2.7 measured at 372° C. by the method of ASTM D-1238 modified as described in U.S. Pat. No. 4,380,618.

Polymer Binder

Polyamide-Imide resin (PAI) is Torlon® AI-10 poly(amide-imide) (Amoco Chemicals Corp.), as solid resin (which can be reverted to polyamic salt) containing 6-8% of residual NMP. Polyamic acid salt is generally available as polyamic acid having an inherent viscosity of at least 0.1 as measured as a 0.5 wt % solution in N,N-dimethylacetamide at 30° C. It is dissolved in a coalescing agent such as N-methyl pyrrolidone, and a viscosity reducing agent, such as furfuryl alcohol and reacted with tertiary amine, preferably triethyl amine to form the salt which is soluble in water, as described in greater detail in U.S. Pat. No. 4,014,834 (Concannon).

A primer composition of PTFE/FEP/PAI is formulated according to the composition in Table 3 and a PTFE/PFA topcoat composition is formulated according to the composition in Table 4. A 1 mil (25 micrometers) thick sheet of aluminum foil is prepared and coated as described in Example 1. The primer is applied at 0.2-0.3 mils (5-8 micrometers) DFT and air dried. The topcoat is applied to give a total DFT of 0.7-0.9 mils (18-23 micrometers). The system is baked for five minutes at 815° F. (435° C.) to produce a disposable insert for use in an electrically heated cooking device. The baked film is glossy, black and the surface is very smooth. Cooking tests for a cooking device using the insert are described in Example 3.

TABLE 3
Primer composition

| Ingredient | Weight % |
|---|---|
| PTFE Dispersion | 11.770 |
| Alumina | 3.381 |
| FEP Dispersion | 8.044 |
| Polyamide-Imide Polymer | 5.397 |
| Mica | 0.050 |
| Zinc Oxide | 0.008 |
| Ultramarine Blue | 6.796 |
| Surfactant | 0.038 |
| Water | 55.981 |
| N,N-Diethyl-2-Aminoethanol | 0.685 |
| Triethylamine | 1.371 |
| Furfuryl Alcohol | 3.781 |
| NMP | 2.698 |
| Total | 100.000 |

TABLE 4
Topcoat composition

| Ingredient | Weight % |
|---|---|
| PTFE Dispersion | 47.353 |
| PFA Dispersion | 20.293 |
| Sodium polnaphthalene | 0.031 |
| sulfonate | |
| Acrylic Polymer | 12.429 |
| Aromatic Hydrocarbon | 3.065 |
| Mica | 0.392 |
| Carbon Black | 0.385 |
| Ultramarine Blue | 0.169 |
| Cerium Octoate | 0.603 |
| Diethylene Glycol Monobutyl | 2.503 |
| Ether | |
| Oleic Acid | 1.266 |
| Octylphenoxypolyethoxyethanol | 0.705 |
| Surfactant | |
| Water | 2.698 |
| Triethanolamine | 4.765 |
| Total | 100.000 |

### Example 3

### Comparative Cooking Tests

The inserts prepared in Examples 1 and 2 are tested in an electrically heated cooking device as described in FIG. 2 and compared to a prior art device. The prior art device is a two-sided cooking device (clamshell cooker) which uses a fluoropolymer impregnated fiberglass cloth (total thickness 125 micrometers) available from Chemical Fabrics Incorporation, North Bennington, Vt., affixed to the upper metal platen. Both cooking devices are carefully controlled using thermostats to control temperature and timers to control cooking time. Quarter pound meat patties are cooked in the devices. The devices were run side-by-side to keep variables to a minimum. Frozen, raw patties are placed on the heated metal base (350° F., 177° C.) of each cooking device and a heated metal platen (425° F., 218° C.) is lowered so that the nonstick surface on the platen comes into intimate contact with the patty. The platens in both devices are adjusted so that the gap when closed remains constant and the pressure on the meat during cooking is the same. The platen remains in contact with the patty for 108 seconds causing the internal temperature of the patty to reach at least 156 ° F. (69° C.). The upper metal platen is lifted and the cooked patty is evaluated.

Patties produced using the device of the present invention with inserts from both Examples 1 and 2 are visually observed to have a higher degree of searing on the top surface than patties produced in the prior art device. Further, patties from both devices are evaluated by a panel in a blind taste test. Consistently the patties of the invention device using foil inserts prepared according to Examples 1 and 2 are reported to taste better, have improved flavor and better texture than the patties produced on the prior art device.

In a separate evaluation, a panel rated the patties prepared using the devices with inserts from Examples 1 and 2 as more pleasing to the eye, being brown and crisp on both sides of the patty. In contrast, the patties produced by the prior art device have a top surface that appears somewhat gray, being less seared than the bottom surface of the patty.

In further testing, the internal meat temperature of cooked patties is compared. In these tests, patties produced using the invention device with foil inserts prepared according to Example 1 are compared to patties from the prior art device. The cooking procedure as described above is the same except that the patties are cooked for a selected duration as shown in Table 5. Immediately after lifting the upper metal platen, a temperature probe records the meat temperature. Temperature measures are averages of at least five readings and are listed in Table 5.

TABLE 5
Cooking Evaluation

| | Coated Foil Insert | Fiberglass Insert |
|---|---|---|
| Cooking | Example 1 | Prior Art |
| Time | Avg Temp | Avg Temp |
| in secs | ° F. (° C.) | ° F. (° C.) |
| 108 | 187.8 (86.6) | 178.2 (81.2) |
| 108 | 181.2 (82.9) | 174.6 (79.2) |
| 102 | 180.2 (82.3) | 173.0 (78.3) |
| 96 | 189.9 (87.7) | 184.0 (84.4) |
| 90 | 168.8 (76.0) | 152.6 (67.0) |

The results show a measurably higher meat temperature, when the coated foil inserts prepared according to the invention are used. A higher average meat temperature ranging from 5-16° F. results when cooking patties with the cooking device of the present invention as compared the prior art device. The temperature of the meat after a carefully controlled cook is a very important parameter as it relates to health and safety, i.e. destruction of bacteria. The device of present invention permits production of safe, good quality product in a reduced amount of time that is highly desirable to commercial production.

In conducting comparative cooking tests, hundreds of meat patties are cooked simulating conditions for commercial operation. Cleaning of the prior art device between cooking tests is more difficult than cleaning the cooking device of the present invention. The fluoropolymer impregnated fiberglass cloth used in prior art device has a cloth textured surface which allows food particles and fats to accumulate sticking to the cloth's surface and penetrating through to the metal platen. When applying a damp cloth for cleaning, additional wipes and more pressure are needed to remove food particles from the fiberglass cloth between cooking cycles. After extensive testing, the insert of the prior art device must be removed and thoroughly washed; fats and residues must be cleaned from the platen itself. In contrast, cleaning the cooking device of the present invention with a single swipe of a damp cloth may be easily achieved due to the smooth surface of the coated foil insert. If damage does occur, the coated foil insert is easily and inexpensively replaced. This operation is distinctly different from cleaning a prior art device in which a nonstick polymer resin coating is applied directly to the platen In that operation, additional care is needed so as not to prematurely damage the coating precipitating an expensive and lengthy recoating operation.

### Example 4

### Box-shaped Insert

The fluoropolymer components and polymer binder are the same as those identified in Example 2. A primer composition of PTFE/FEP/PAI is formulated according to the composition in Table 6 and the same PTFE/PFA topcoat composition in Example 2 formulated according to the composition in Table 4 is used. A 5 mils (127 micrometers) thick sheet of aluminum foil is prepared and coated with the nonstick formulation under the same application conditions as described in Example 2. A strip, measuring 23.5 inches (59.7 cm)×19.125 inches (48.6 cm), is cut from the foil strip and formed into disposable insert 30 having a configuration as shown in FIG. 3. Fold lines 42 form tabs, sidewalls, and side flaps. Flaps 33 of sidewall 34 mate with flaps 35 at one end of sidewalls 36 and 40 to form the crimped front corners of the box. Tabs 37 of sidewalls 36 and 40 are mated with tabs 39 of sidewall 38 to form the back corners of the box. In this example, flaps 70 on sidewalls 36 and 40 form slots 44 in sidewall 38 upon erection of the box, flaps 71 being omitted. Flaps 70 are enlarged in the direction of tabs 39 so they can be crimped to add strength to the rear corners of the box. The dimensions of base 32 of the completed insert (using the reference numerals as indicated in FIG. 4) are 17.75 inches (45.1 cm)×14.5 inches (36.8 cm). Sidewalls 34,36,38 and 40 are each 2.5 inches (6.4 cm) deep. Each of the sidewalls has a crimped bead formed from ¾ inches (1.9 cm) of folded foil along the open side of the box to form reinforced top edges.

The box-shaped insert is installed on the upper metal platen of a two-sided electrically heated cooking device as described in FIG. 7. The platen is manufactured by Taylor Freezer Sales Co., Inc of Chesapeake, Va. The insert is installed so that it wraps around the upper platen with an overlap extending about 40% of the sidewall of the upper platen and so that the nonstick coating faces the lower heated platen.

The two-sided cooking device with the box-shaped insert is compared to a prior art two-sided cooking device having a new fluoropolymer impregnated fiberglass release cloth (total thickness 125 micrometers) affixed to the upper metal platen of the same grill. The cloth is a planar, unformed sheet that extends over the heating surface of the platen but does not extend over the sidewalls.

Prior to installing the box-shaped insert and the fiberglass insert, the upper platen on the cooking device is thoroughly cleaned for each test. Thorough cleaning includes the use of a high temperature grill cleaner that is a caustic solvent and the use of a scouring pad made from synthetic fibers. Quarter pound frozen meat patties are cooked in the device under commercial conditions under the following conditions for each insert in each test. The device cooks 6 patties in cycles of less than 2 minutes. In this test under commercial cooking conditions, the device is used continuously for 14 hours a day. The nonstick surface of the heated upper metal platen comes into intimate contact with the patties for hundreds of cycles.

Fiberglass Insert Test: As described above, the fiberglass cloth insert is installed on a clean platen. At the end of each day, the fiberglass insert is removed. When using the fiberglass insert, a heavy build-up of carbonized cooking residue from cooking grease is observed on the platen every day. The platen is thoroughly cleaned each day as described above. The fiberglass cloth insert with its porous, textured surface also requires a rigorous cleaning using high temperature grill cleaner. The total cleaning procedure takes approximately ½ hour each day. The cleaned insert is air dried each night in preparation for the next day's cooking and then reinstalled on the cooking device each morning. After 10 days, the fiberglass cloth loses its release characteristics and needs to be replaced.

Box-Shaped Insert Test: The box-shaped insert is installed on a clean platen. In contrast to the fiberglass cloth insert, after each of the first two days of cooking, the box-shaped insert is left in place and wiped clean in place, first with a soapy cloth and then a rinsed damp cloth. The smooth nonstick surface of the coated foil insert is easily cleaned by this fast, easy wiping procedure. The upper platen is not cleaned. After 2.5 days, the box-shaped insert is removed for inspection of the platen. Some trace grease is wiped out from the inside of the box-shaped insert with a paper towel. The upper heated platen is observed to have no carbon residue buildup, just a trace of grease is observed along the surface of the back of the platen near where slotted sidewall 38 and base 32 meet. The box-shaped insert is reinstalled without cleaning the platen. At the end of the 3^{rd} and 4^{th} days of cooking, the box shaped insert is left in place and wiped cleaned as described above.

At the end of the 5^{th} day of cooking, the box-shaped insert is removed for inspection. Again, the upper heated platen is observed to have no carbon residue buildup, just a trace of grease is observed along the surface of the back of the platen near where slotted sidewall 38 and base 32 meet. Some trace grease is wiped out from the inside of the box-shaped insert with a paper towel. The trace residue of grease is cleaned from the platen using soap and water. This cleaning procedure takes less than 5 minutes. The box-shaped insert is reinstalled for the next day's cooking. After 7.5 days the procedure described after 2.5 days is repeated. After 12 days, the procedure described after 5 days is repeated. Each night, except as described on the 12^{th} day, the insert is left in place and wiped clean. After 14 days, the nonstick coating on the box-shaped insert begins to lose its release characteristics and the hamburgers begin to stick to the foil. After 15 days, the box-shaped insert is removed in order to replace it. The upper heated platen is observed to have no carbon residue buildup, just a trace of grease is observed along the surface of the back of the platen near where slotted sidewall 38 and base 32 meet.

As shown in this example, the fiberglass cloth acts as a grease trap and permits cooking volatiles to seep under its planar configuration and penetrate its porous, textured surface. Cooking volatiles visible as smoke emanating during cooking build up on the platen surface and become carbonized. Carbonized residues are difficult to remove and interfere with the heat transfer capability of the platen.

In contrast, the box-shaped insert forms a barrier to the volatiles generated from cooking. The insert lies snugly against the sidewalls preventing volatiles from getting beneath the insert and depositing on the heating surface. Daily cleaning of the upper heated platen is unnecessary saving much time and labor. Replacement is easy and economical with the insert of this invention.

Because of the good heat transfer characteristics of the heat conducting coated foil insert, patties produced using the device with the box-shaped insert are observed to have a higher degree of searing on the top surface than patties produced with the device using a fiberglass insert.

TABLE 6
Primer composition

| Ingredient | Weight % |
|---|---|
| PTFE Dispersion | 7.923 |
| Alumina modified silica | 3.577 |
| FEP Dispersion | 5.875 |
| Polyamide-Imide Polymer | 5.654 |
| Mica | 0.050 |
| Zinc Oxide | 0.008 |
| Ultramarine Blue | 7.181 |
| Aluminum silicate | 0.217 |
| Sodium Polynapthalene | 0.012 |
| Sulfonate | |
| Octylphenoxypolyethoxyethanol | 0.063 |
| Surfactant | |
| Water | 60.474 |
| Triethanolamine | 0.003 |
| N, N-Diethyl-2-Aminoethanol | 0.718 |
| Triethylamine | 1.436 |
| Furfuryl Alcohol | 3.982 |
| NMP | 2.827 |
| Total | 100.000 |

The present invention satisfies the need of the fast food industry for a commercial cooking device with a disposable nonstick layer that can rapidly produce a product with improved aesthetic appeal and desirable taste in an economic system.

What is claimed is:

1. An electrically heated cooking device comprising:
a. an electrically heated surface for cooking/heating food; and
b. a disposable insert comprising a metal foil substrate coated with a nonstick polymer resin which insert is replaceably affixed to said electrically heated surface so that said nonstick polymer coating on said metal foil substrate is in intimate contact with food being cooked/heated.

2. A two-sided cooking device comprising:
a. a metal base having a surface to receive food to be cooked for heating and thereby cooking said food;
b. an upper heated metal platen positioned over said metal base; and
c. a disposable insert comprising a metal foil substrate coated with a nonstick polymer resin, which insert is replaceably affixed to at least said upper platen and positioned so said nonstick polymer coating on said metal foil substrate is in intimate contact with food on said heated base when said upper platen engages said metal base during the process of cooking.

3. The two-sided cooking device of claim 2 wherein said platen comprises a heating surface facing said metal base and structure supporting said heating surface, including a sidewall encasing the periphery of said heating surface, and said disposable insert includes a sidewall which overlaps said sidewall of said platen, thereby forming a barrier to the volatiles from cooking coming into contact with said heating surface.

4. The two-sided cooking device of claim 3 wherein said nonstick polymer coating also covers said sidewall of said disposable insert.

5. A clamshell cooker for cooking a meat patty comprising a metal base for heating the bottom of said patty, an upper metal platen positioned over said metal base for heating the top of said patty, and a disposable insert replaceably affixed to at least said upper platen, the improvement comprising a disposable insert of metal foil coated with a nonstick polymer resin covering said upper metal platen, with said nonstick polymer coating facing said metal base.

6. The clamshell cooker of claim 5 wherein said disposable insert includes a portion that wraps around said upper metal platen.

7. The clamshell cooker of claim 6 wherein said nonstick polymer coating is also present on said portion of said disposable insert which wraps around said upper metal platen.

8. The clamshell cooker of claim 5 wherein said coating comprises a nonstick polymer resin having a thickness in the range of 0.1 mil (2.5 micrometers) to 3 mils (76 micrometers).

9. The cooking device of claim 1 wherein said insert comprises a metal foil which is aluminum.

10. The cooking device of claim 1 wherein said insert comprises a metal foil which is stainless steel.

11. The cooking device of claim 1 wherein said insert comprises a metal foil wherein the surface of said metal foil is uninterrupted with perforations.

12. The cooking device of claim 1 wherein said insert comprises a metal foil coated with a nonstick polymer resin comprising a fluoropolymer resin and a heat resistant polymer binder.

13. The cooking device of claim 12 wherein said insert comprises a metal foil coated with a nonstick polymer resin comprising a primer layer of fluoropolymer resin and a heat resistant polymer binder plus at least one overcoat comprising a fluoropolymer resin.

14. The cooking device of claim 13 wherein said nonstick polymer resin coating has a thickness in the range of 0.1 mil (2.5 micrometers) to 3 mil (76 micrometers).

15. A process for cooking food comprising:
a. placing uncooked food on a heated metal base,
b. lowering a heated metal platen affixed with a disposable insert of metal foil coated with a nonstick fluoropolymer resin over said food, the coating of nonstick resin facing said food, so that said insert is in intimate contact with said food, the heat flowing through said coated insert causing said food to cook,
c. lifting said metal platen from said food leaving little food residue on said insert; and
d. removing said cooked food from said heated metal base, wherein the process results in substantially equivalent browning on both sides of said food.

16. The process of claim 15 wherein said uncooked food is a frozen, raw meat patty which is cooked so that substantially equivalent searing results on both sides of said cooked meat patty.

17. A metal foil substrate coated with a nonstick polymer resin used as an insert in an electrically heated cooking device where said coated substrate in intimate contact with food promotes accelerated cooking while providing a release surface, said coating comprising a nonstick polymer resin having a thickness in the range of 0.1 mil (2.5 micrometers) to 3 mils (76 micrometers).

18. The coated substrate of claim 17 wherein said metal foil is aluminum.

19. The coated substrate of claim 17 wherein said metal foil is stainless steel.

20. The coated substrate of claim 17 wherein the surface of said metal foil is uninterrupted with perforations.

21. The coated substrate of claim 17 wherein said nonstick coating comprises a fluoropolymer resin and a heat resistant polymer binder.

22. The coated substrate of claim 17 wherein said nonstick coating comprises a primer layer of fluoropolymer resin and a heat resistant polymer binder plus at least one overcoat comprising a fluoropolymer resin.

23. The coated substrate of claim 17 in the form of a base portion and a sidewall portion extending out of the plane of said base portion, thereby forming a box shape, the side opposite from the base portion being open, the outside of said base portion having said coating thereon.

24. The coated substrate of claim 23 wherein the outside of said sidewall portion also has said coating thereon.
